(19) United States
(12) Patent Application Publication
(10) Pub. No.: US 2017/0366106 A1
(43) Pub. Date: Dec. 21, 2017

(54) USING PIEZOELECTRIC ELEMENTS IN A HYDROELECTRIC SYSTEM

(71) Applicant: Edwin Newman, Palmdale, CA (US)

(72) Inventor: Edwin Newman, Palmdale, CA (US)

(21) Appl. No.: 15/186,541

(22) Filed: Jun. 20, 2016

(51) Int. Cl. H02N 2/18

(52) U.S. Cl. CPC H02N 2/185

(57) ABSTRACT

A hydroelectric system comprising a pipe from a water source at a high elevation which is made to open into a pressurized water filled chamber at a much lower elevation. The chamber contains a waterproofed piezoelectric element and waterproofed electric leads connected to the electric grid. The inlet pipe is divided into several pipes before being made to operatively connect to the chamber. Each of the several inlet pipes have their water flow regulated by a solenoid operated valve. Corresponding solenoid operated outlet valves are also provided. A rotary electric switch is also provided so as the switch arm is rotated the inlet and outlet valves are opened and closed in succession, causing waves of pressure on said piezoelectric material to produce electric power.

This invention is a development of information in Patent Application 20150101323.

### BACKGROUND OF THE INVENTION

Clingman, (U.S. Patent Application 20080315722) uses a spring, operated mechanically to produce waves of pressure on piezoelectric material to produce electricity. However, springs wear out, especially at higher frequencies and pressures.

Rozycki (U.S. Pat. No. 4,442,755) shows a closed water filled chamber whose volume is divided by a piston within the chamber. He uses a motorized rotating mechanical switch to supply pressurized water alternately to each side of the piston to make the piston vibrate. Operation of the switch involves rubbing two plates together, each with its own set of holes. This rubbing causes friction and increases the load on the motor. At higher angular velocities this action causes more wear on each plate.

It would be advantageous to find a way to alternately pressurize and depressurize piezoelectric material at higher frequencies and pressures with a minimum of energy expenditure.

Piezoelectric material can convert waves of pressure energy into electric energy. The amount of energy converted is directly dependent on the amplitude and frequency of the wave. Yet the focus of present research is on microgenerators. See for instance CPC class H02N2/186.

### SUMMARY OF THE INVENTION

Residential water pressure in Palmdale, Calif. is about 70 psi or 100 psi at the street. Palmdale is about 2500 ft. above sea level. A source of water is from wells. This well water supply needs to be pumped uphill and while the volume is not great it is a load on the pumps. On a large scale the picture is different. Water outlets in the spirit of this invention could be situated along the Pacific coast at about 10-20 ft. above sea level. Water from the Sierra mountain range would be piped into these water outlets. Lake Crowley, for example, has a surface elevation of 6781 ft. above sea level. The city of Fresno is only about 80 miles away and its elevation is 308 ft. above sea level. The Pacific Ocean is about 180 miles from Lake Crowley with several mountain ranges in between. But the siphon effect within a transporting pipe means that no pumping of water uphill is needed. And this great difference in elevation will insure a great system efficiency. Pipe friction would be minimized by installing a large diameter pipe. Since the elevation difference is so great pipe friction losses would be minimal. Further, a pipe from Lake Crowley to Palmdale could also supply electricity to the city. In both Fresno and Palmdale a parallel pipe system could be made to include a unit of this invention for each house and business. By the use of reverse metering the electricity supplied through this invention could be returned to the Grid which in turn would supply A.C. electrical power to individual customers.

I describe the invention as follows: There is a chamber filled with water and containing waterproofed piezoelectric material indirectly connected to the power grid. There are multiple inlet and outlet pipes, each containing a solenoid operated valve. The inlet pipes are connected to a water source at a high elevation. The outlet pipes are connected to a water reservoir at a low elevation. Opening and closing each inlet and then outlet pipe in succession produces waves of pressure on the piezoelectric material, producing electricity. That is, a very small quantity of water is made to enter the chamber, and then an equal small quantity of water is made to exit the chamber for each cycle of operation. The solenoids are operated by a rotary electric switch operated by a motor.

The aim of the invention is to greatly increase the amplitude and frequency of pressure waves made to impact piezoelectric material so as to greatly enhance the possible electric output of piezoelectric elements and eliminate the need for turbines and generators in hydroelectric power systems.

### BRIEF DESCRIPTION OF THE DRAWINGS

Figure one is a side view of a cross section of the chamber, piezoelectric material and inlet and outlet pipes.

FIG. 2 is a schematic diagram of how the valves are operated electrically.

### DETAILED DESCRIPTION OF THE PREFERRED EMBODIMENT

In FIG. 1 we see an inlet pipe 1 divided into inlet pipes 1a-d led into chamber 3. Each inlet pipe 1a-d contains a solenoid operated valve V1-4 respectively. Chamber 3, as well as inlet pipes 1,1a-d are completely filled with water under pressure. Within chamber 3 is piezoelectric material 4 which is laminated with a dielectric flexible substance 5 for the purpose of waterproofing piezoelectric substance 4. Waterproof wiring+ and − are affixed to opposite sides of piezoelectric material 4 to remove any electricity produced by this invention. Outlet pipes 2a-d are connected so as to exhaust water from chamber 3. Each outlet pipe 2a-d has its water flow regulated by a solenoid operated valve V5-8. Each outlet pipe is completely full of water and is led to a reservoir open to the atmosphere. The elevation of valves V5-8 above the surface of the reservoir should not be above 34 ft. to prevent vacuum bubbles from appearing in pipes 2a-d.

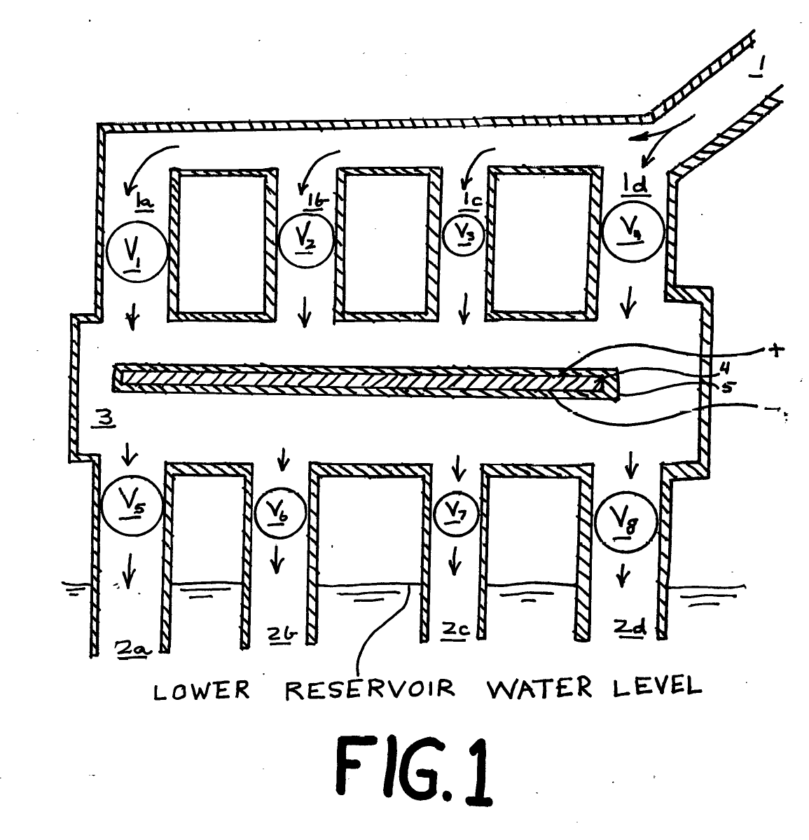

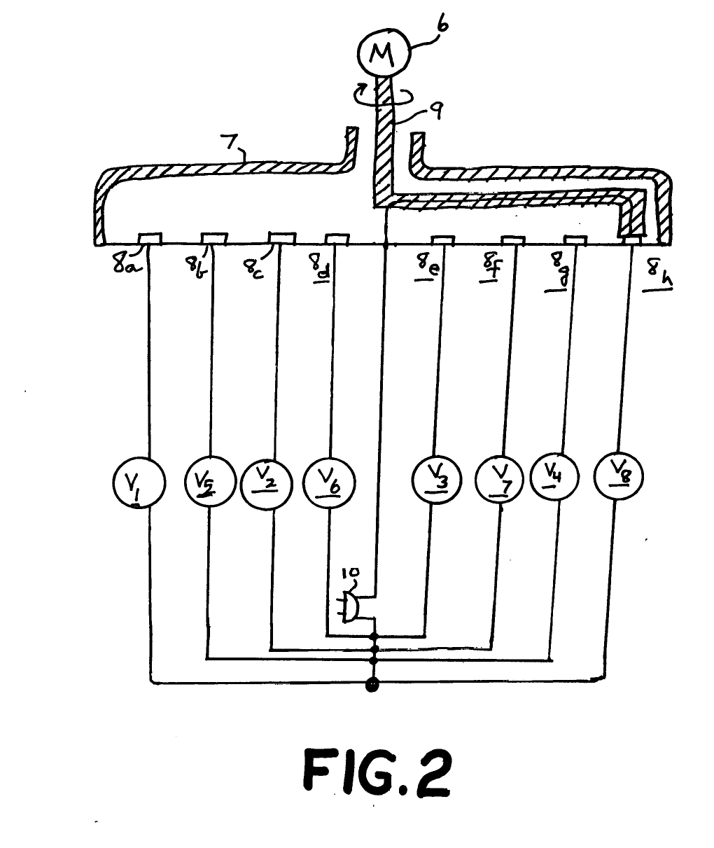

In FIG. 2 we see a rotary electrical switch, such as an automobile distributor, operated by motor 6. There is a rotor arm 9 containing wire 8i made to run from the end of the arm to electric plug 10. Switch casing 7 contains electric contacts 8a-h. Each electric contact is at one end of a wire led to a solenoid which is made to operate a valve V1-8. Each other wire to a solenoid is connected to electric plug 10.

In operation, as motor 6 is made to revolve rotor arm 9 valves V1-8 are made to open and close in succession. The angular velocity of rotor arm 9 determines the frequency of the electric output of the invention and the elevation of the end of a wire led to a solenoid which is made to operate a valve V1-8. Each other wire to a solenoid is connected to electric plug 10.

In operation, as motor 6 is made to revolve rotor arm 9 valves V1-8 are made to open and close in succession. The angular velocity of arm 9 determines the frequency of the electric output of the invention and the elevation of the reservoir feeding water into inlet pipe 1 determines the amplitude of the pressure waves made to impact the piezoelectric material.

From the above description it is apparent that the preferred embodiment achieves the object of the present invention. Alternative embodiments and various modifications of the depicted embodiment will be apparent to those skilled in the art. For example, the present invention may bused to modify various embodiments of U.S. Pat. Nos. 5,518,554 and 7,043,904 to produce new applications of the present invention.

1. A piezoelectric power generator comprising:
a. a pipe operatively connected to a water source at a high elevation at a first end and filled with water,
b. a chamber operatively connected to a second end of said pipe which is at a lower elevation, said chamber filled with water and also containing waterproofed piezoelectric material operatively connected to a power transmission grid,
c. said operatively connection of said inlet pipe comprising a division into a number of inlet pipes, said inlet pipes each regulated by a solenoid operated valve and terminating on the inner wall of said chamber,
d. an equal number of outlet pipes from said chamber led from said chamber to a lower reservoir and the flow through each said outlet pipes regulated by a solenoid operated valve,
e. a motorized electric switch operatively connected to each solenoid, and
f. an electric power source for all solenoids,
so that as said rotary electric switch is made to revolve said valves are made to open and close in succession, causing waves of pressure on said piezoelectric material to produce electric power.
